(19) United States
(12) Patent Application Publication
(10) Pub. No.: US 2004/0081459 A1
(43) Pub. Date: Apr. 29, 2004

(54) Remote test unit within a communications network

(75) Inventors: Alexander Mumm, Kornwestheim (DE); Albrecht Schroth, Herrenberg (DE); Horst Nill, Eutingen (DE)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/421,146

(22) Filed: Apr. 24, 2003

(30) Foreign Application Priority Data
Oct. 29, 2002 (EP) 02 024 089.1

(51) Int. Cl. H04B 10/08

(52) U.S. Cl. 398/16

(57) ABSTRACT

A communications network is described comprising a cable and a remote test unit being coupled to the cable. Optical data signals are transmitted with a first wavelength on the cable. The remote test unit is adapted to transmit optical test signals as well as optical result messages with a second wavelength to the cable.

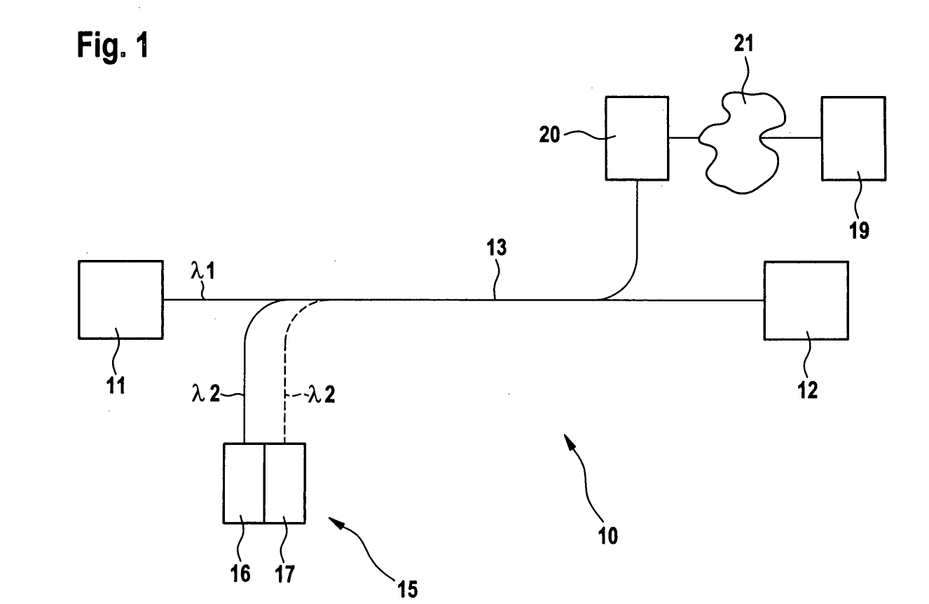

The invention relates to a method for operating a communications network. The invention also relates to a communications network and to a remote test unit within a communications network.

It is known to transmit optical data signals on a cable of the communications network. It is also known to couple a remote test unit to the cable of the communications network and to monitor and test the cable by the remote test unit with respect to defects. If a defect is detected by the remote test unit, a result message is generated and reported e.g. to a central management system of the communications network.

For the purpose of reporting defects, the Internet and/or a Intranet and/or a LAN (local area network) and/or the like is used.

It is an object of the invention to provide a method for operating an communications network with an improved reporting of defects.

This object is solved by a method according to claim 1. As well, the object is solved by a communications network according to claim 3 and by a remote test unit according to claim 4.

According to the invention, the communications network itself is used not only for the transmission of optical data signals, but as well for the transmission of the result messages from the remote test unit e.g. to the central management system. The communications network itself, therefore, is used for the reporting of defects.

As an advantage, the remote test unit does not have to use the Internet or the Intranet or the like to report a defect e.g. to the central management system. Instead, the communications network itself is used by the remote test unit. Therefore, no additional devices or the like are necessary.

Furthermore, the wavelengths of the optical data signals and the optical result messages are different. Therefore, the result messages sent out by the remote test unit over the communications network do not influence or disturb any optical data signal being transmitted. The wavelength used by the optical result message is identical with the wavelength of the optical test signals generated by the remote test unit for monitoring and testing the respective cable of the communications network.

An exemplary embodiment of a method for operating a communications network according to the present invention will be explained in detail referring to the drawing. The only FIGURE of the drawing shows a part of a communications network according to the invention.

In the FIGURE, a part of a communications network 10 is shown. A transmitter 11 is connected with a receiver 12 via a cable 13. The transmitter 11 is adapted to transmit optical data signals to the receiver 12 with a first wavelength λ1.

The communications network 10 comprises a huge number of cables so that the optical data signals with the wavelength λ1 which are transmitted from the transmitter 11 to the receiver 12, may be forwarded within the communications network 10 as needed.

In order to monitor and test the transmission path of the network 10 including the cable 13 of the communications network 10 shown in the FIGURE, a remote test unit 15 is provided. The remote test unit 15 comprises an optical time domain reflectometer 16 and a computer system 17. The optical time domain reflectometer 16 is coupled with the computer system 17 so that data may be exchanged between these devices.

The optical time domain reflectometer 16 is connected with the cable 13 and is able to transmit and receive optical test signals with a second wavelength λ2. The optical time domain reflectometer 16 is therefore able to send out test signals with the wavelength λ2 into the cable 13 and to receive all reflected signals of these test signals which are reflected on their way through the cable 13 to the receiver 12.

If the cable 13 has a defect, the reflected signals are influenced and changed by the defect. In particular, a break of the cable 13 creates a peak and a subsequent degradation of the received reflected signals. As already outlined, the reflected signals are then received by the optical time domain reflectometer 16.

After their receipt, the reflected signals are evaluated in particular with respect to changes due to defects. These evaluations are carried by the computer system 17 of the remote test unit 15.

If a defect of the cable 13 is detected, this defect has to be reported e.g. to a central management unit 19 within the communications network 10. For that purpose, a corresponding negative result message has to be sent by the remote test unit 15 to this central management system 19 e.g. via another remote test unit 20 and a local area network 21.

If no defect is detected, the remote test unit 15 may also send out a corresponding positive result message.

The computer system 17 creates the corresponding result message and transmits the result message to the cable 13. This may be done directly according to the dashed line in the FIGURE, or indirectly with the help of the optical time domain reflectometer 16.

In the first case, the computer system 17 is able to send the result message in the form of optical signals with the wavelength λ2 to the cable 13. From there, the result message is forwarded to the afore-mentioned central management system 19.

In the second case, the computer system “uses” the optical time domain reflectometer 16 to send the result message in the form of optical signals with the wavelength λ2 to the cable 13. From there, the result message is forwarded again to the central management system 19.

In both cases, the result message is sent via the cable 13 in the form of optical signals with the wavelength λ2. The wavelength λ2 which is usually used for sending out the optical test signals, is used for transmitting the afore-mentioned optical result message.

The optical result message, therefore, does not require any additional lines, cables or the like for its transmission. Instead, the cable 13 and then the entire communications network 10 is used for the transmission of the result message.

Furthermore, due to the fact that the optical data signals have the wavelength λ1, that the optical test signals have the wavelength λ2 and that the optical result message is sent with the same wavelength as the optical test signals, the transmission of the result message does not influence or disturb at all any transmission of optical data signals.

The communications network 10, therefore, is not only used for the transmission of optical data signals but also for the transmission of optical result messages resulting from a test of the communications network 10.

It is furthermore possible to use the communications network 10 in a similar manner to initiate a test of the communications network 10. For that purpose, e.g. the central management system 19 sends a corresponding instruction message via the communications network 10 in the form of an optical signal with the wavelength λ2 to the remote test unit 15.

As a further possibility, the central management system 19 may send a request to the remote test unit 15 to transmit the current status of the monitored part of the communications network 10. This may then be carried out by the remote test unit 15 by sending a corresponding status message via the communications network 10 in the form of an optical signal with the wavelength λ2 to the central management system 19.

1. A method of operating a communications network comprising a cable to transmit optical signals, wherein optical data signals are transmitted by a transmitter with a first wavelength on the cable, and wherein optical test signals as well as optical result messages are transmitted by a remote test unit with a second wavelength on the cable.

2. The method of claim 1 wherein the optical data signals are forwarded within the communications network, wherein the optical test signals are provided for testing the cable with respect to defects, and wherein the optical result messages are forwarded within the communications network.

3. A communications network comprising a cable and a remote test unit being coupled to the cable, wherein optical data signals are transmitted with a first wavelength on the cable, and wherein the remote test unit is adapted to transmit optical test signals as well as optical result messages with a second wavelength to the cable.

4. A remote test unit being coupled to a cable of a communications network, wherein optical data signals are transmitted with a first wavelength on the cable, and wherein the remote test unit is adapted to transmit optical test signals as well as optical result messages with a second wavelength to the cable.

5. The remote test unit of claim 4 comprising an optical time domain reflectometer for generating the optical test signals and for receiving the reflected signals from the cable.

6. The remote test unit of claim 5 comprising a computer system being coupled with the optical time domain reflectometer for evaluating the reflected signals and for generating the result message if a defect is detected.

7. The remote test unit of claim 6 wherein the computer system is adapted to transmit the result message directly as an optical signal with the second wavelength to the cable.

8. The remote test unit of claim 6 wherein the computer system transmits the result message indirectly with the help of the optical time domain reflectometer as an optical signal with the second wavelength to the cable.
